(19) United States
(12) Patent Application Publication
(10) Pub. No.: US 2015/0193814 A1
(43) Pub. Date: Jul. 9, 2015

(54) SYSTEMS AND METHODS FOR CONTEXT-BASED VIDEO ADVERTISING

(71) Applicant: Adknowledge, Inc., Kansas City, MO (US)

(72) Inventors: Kevin Eppinger, Kansas City, MO (US); Jeff Parker, Kansas City, MO (US); Deebu Jacob, Mission, KS (US); Corianne E. Turnier, Fort Myers, FL (US)

(21) Appl. No.: 14/564,444

(22) Filed: Dec. 9, 2014

Related U.S. Application Data
(60) Provisional application No. 61/925,073, filed on Jan. 8, 2014.

(51) Int. Cl. G06Q 30/02

(52) U.S. Cl. CPC G06Q 30/0242; G06Q 30/0277

(57) ABSTRACT

A method for context-based video advertising comprises analyzing content associated with a publisher website and identifying one or more video advertisement segments that exceeds a threshold relevance to the content associated with the publisher website. The method also comprises providing the identified one or more of the video advertisement segments for publication to the publisher website. The method further comprises receiving information indicative of the user interaction with the video advertising segment on the publisher website, and determining a cost associated with the video advertising segment, the cost being based, at least in part, on the user interaction with video advertising segment.

### TECHNICAL FIELD

The present disclosure relates generally to online and mobile advertising and, more particularly, to a context-based video advertising system and associated methods.

### BACKGROUND

Content distribution over the Internet has rapidly increased in recent years, all data indicates that this trend will continue in the foreseeable future. The Internet has also spawned completely new platforms for data communication and distribution. Indeed, various forms of social media can be attributed almost exclusively to the growth of the Internet and Internet-based communication platforms. With the relatively recent and rapid proliferation of smart phones, tablets, and other mobile computing platforms, many users are increasingly relying on the Internet as the preferred marketplace for the distribution and consumption of content. Such an increase in Internet traffic has created a significant marketing opportunity for content publishers and advertisers alike, with content publishers looking to generate new revenue streams through advertising over the Internet and advertisers looking ensure that marketing resources are being allocated appropriately to reach a desired target audience.

In the early days of Internet advertising, advertisers would approach owners of popular websites and request webpage space to place image-based “banner” advertisements on the owner's website in exchange for a fee, much in the same manner as print advertising. As the demand for Internet advertising space grew, companies specializing in Internet advertising services began looking for ways to match website owners/publishers with advertisers in order to maximize revenue for the website owner/publishers, while providing the most relevant marketing segment for a particular product being advertised.

Furthermore, as Internet bandwidth speeds began increasing (particularly in the mobile device space), the ability to place high-bandwidth advertising content, such as full-length video commercials, also increased. Importantly, however, unlike broadcast and print media, Internet media, particularly those involving social networks, social and online gaming, and even web-browsing, provide a high degree of user-interaction. This user-interaction data can be collected and analyzed in various ways, providing a wealth of information about target demographics, user browsing behavior, differences in regional and geographical cultures, etc. Importantly, however, existing video advertising solutions are insufficient in merging content delivering solutions with the ability to identify and monitor user-interaction metrics in a complete virtuous cycle that increases ad revenue for the website owner/publishers while also increasing the market segment reach for advertisers.

The presently disclosed systems and methods context-based Internet video advertising are directed to overcoming one or more of the problems set forth above and/or other problems in the art.

### SUMMARY

According to one aspect, the present disclosure is directed to a method for context-based video advertising that comprises analyzing, at a computer system, content associated with a publisher website, and identifying, at the computer system, one or more video advertisement segments that exceeds a threshold relevance to the content associated with the publisher website. The method may also include providing, by the computer system, the identified one or more of the video advertisement segments for publication to the publisher website. The method may further include receiving, at the computer system, information indicative of the user interaction with the video advertising segment on the publisher website. The method may also include determining, by the computer system, a cost associated with the video advertising segment, the cost being based, at least in part, on the user interaction with video advertising segment.

In accordance with another aspect, the present disclosure is directed to a method for context-based video advertising that comprises analyzing, by a processor associated with a computer system, content associated with a publisher website, and determining, by the processor, information indicative of a subject matter of the analyzed content. The method may also comprise identifying, by the processor, one or more video advertisement segments that exceeds a threshold relevance to the subject matter of the analyzed content. The method may further comprise calculating, by the processor, a relevance score for each of the identified video advertisement segments, and selecting, by the processor based, at least in part, on the calculated relevance score, at least one of the identified video advertisement segments for publication to a publisher website. The method may further include providing, by the processor, the selected at least one of the video advertisement segment for publication to the publisher website.

In accordance with another aspect, the present disclosure is directed to a system for context-based video advertising, comprising a video advertising database having stored therein a plurality of video advertising segments. The system may also comprise an information extraction module. The information extraction module may be configured to extract content associated with the publisher website and identify one or more keywords associated with the extracted content from the information extraction service. The system may also include an advertisement interface module communicatively coupled to the video advertising database and the information extraction module. The advertisement interface may be configured to identify one or more video advertisement segments that exceeds a threshold relevance to the content associated with the publisher website, based on the received keywords associated with the extracted content. The advertisement interface may also be configured to provide the identified one or more of the video advertisement segments for publication to the publisher website. The advertisement interface may be further configured to receive information indicative of the user interaction with the video advertising segment on the publisher website. The advertisement interface may also be configured to determine a cost associated with the video advertising segment, the cost being based, at least in part, on the user interaction with video advertising segment.

### BRIEF DESCRIPTION OF THE DRAWINGS

FIG. 1 illustrates an exemplary network environment in which processes and methods for context-based video advertising consistent with certain disclosed embodiments may be implemented;

FIG. 2 provides a schematic block diagram of exemplary components associated with a video advertising system in which processes and methods for context-based video advertising may be implemented, in accordance with certain disclosed embodiments;

FIG. 3 illustrates a block diagram of exemplary components and modules associated with an online advertising database that may be used in accordance with certain exemplary disclosed embodiments;

FIG. 4 provides a flowchart depicting an exemplary process for context-based video advertising to be performed by one or more processing devices associated with an exemplary video advertising system, consistent with certain disclosed embodiments; and

FIG. 5 provides a flowchart illustrating another exemplary process for context-based video advertising to be performed by one or more processing devices associated with an exemplary video advertising system, in accordance with certain disclosed embodiments.

### DETAILED DESCRIPTION

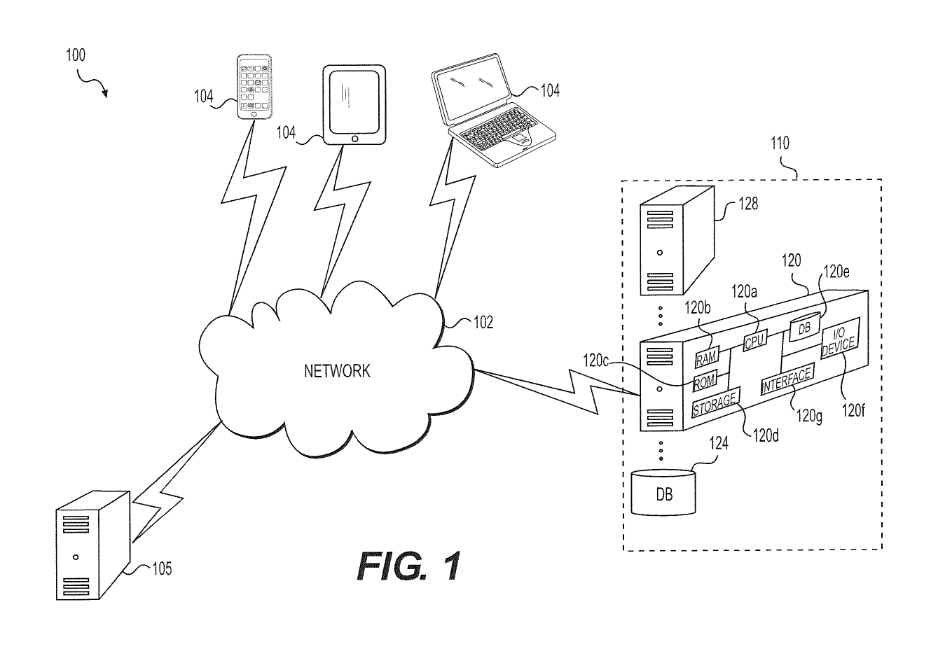

FIG. 1 illustrates an environment 100 in which processes and methods for context-based video advertising consistent with the disclosed embodiments may be implemented. As illustrated in FIG. 1, environment 100 may include one or more publisher systems 102, one or more online advertising systems 110, and one or more end-user devices 104, all of which are coupled together, either directly or indirectly, through network 102. Among other functions, environment 100 provides a platform for delivering published content and advertising content to end-user devices 104 over a communication network, such as the Internet. Exemplary processes by which such published and advertising content is delivered will be described in more detail below. Importantly, the devices and systems illustrated in FIG. 1 are exemplary only, and not intended to be exhaustive or limiting. For example, although not shown, it is contemplated that publisher systems 102, online advertising system 110, and/or end-user devices may be coupled to network 102 via one or more intermediate servers or networks, such as cellular or satellite communication networks.

Publisher system 105 may include one or more devices or network of devices that cooperate to deliver media content to one or more user devices, such as end user devices 104, over communication network 102. According to one embodiment, publisher system 105 may include a web server system associated with a media content provider. This web server system may be configured to publish/deliver media content via one or more websites, and may be associated with a news agency (e.g., print, broadcast, or mixed media format), a online retail store, a social network service, a search engine, a public- or private-interest web-blog (i.e., a blog), or any other type of online media content provider.

End user devices 104 may include any device suitable for accessing content published by publisher system 105 via communication network 102. End user devices may include one or more smart phones, tablets, laptop/desktop/netbook computing devices, wearable media consumption devices (e.g., optical head-mounted display (OHMD), smart watch, etc.), or any other types of processor-based computing system suitable for accessing media content published by publisher system 105 via communication network 102. According to one exemplary embodiment, end user devices 104 may be browser-enabled devices suitable for viewing content delivered by webpages hosted by one or more publisher systems 102.

Online advertising system 110 may include one or more processor-based computer systems or a network of processor-based computer systems, and is configured to provide a number of advertising services for one or more advertisers, content providers, publishers, and website owners associated with online advertising environment 100. According to one embodiment, online advertising system 110 may include, among other things, a home server (HS) 120, a storage database 124, and an advertiser interface 128. Importantly, the listing of components and systems associated advertising system 110 is exemplary only and not intended to be limiting. Indeed, it is contemplated that online advertising system 110 may include additional and/or different components and modules than those listed and shown in FIG. 1. For example, it is contemplated that online advertising system 110 may include an information extraction module, either as part of home server 120 or a standalone module associated with online advertising system 120. Such an information extraction module may, for example, be configured to analyze content associated one or more publisher systems 102 and extract keywords, main topics, frequently used words or phrases, named entities, and/or semantic relationships between multiple words and phrases associated with content on publisher systems 102. Thus, online advertising system 120 may include additional and/or different components than those listed or shown.

As illustrated in FIG. 1, online advertising system 110 (and any other general purpose computing system associated with online advertising environment 100) may include or embody a processor-based computer system that includes a plurality of components that may be programmed to perform tasks associated with online advertising environment 100. Although the specific components are disclosed and illustrated as being associated with online advertising system 110, it is contemplated that any processor-based system (including end user devices 104, publisher system 105, network 102) may include components substantially similar to those described in connection with online advertising system 110, or any other suitable general-purpose computer.

As explained, online advertising system 110 may be any processor-based computing system that is configured to perform tasks associated with the presently disclosed context-based video advertising scheme. Non-limiting examples of online advertising system 110 include a desktop or notebook computer, a tablet device, a smartphone, wearable or handheld computers, or any other suitable processor-based computing system.

For example, as illustrated in FIG. 1, online advertising system 110 may include one or more hardware and/or software components configured to execute software programs, such as software for matching video advertising segments with specific content topics associated with publisher system(s) 105 and determining a cost-basis for charging advertisers (and crediting publishers) based on user interaction with the published advertisements. According to one embodiment, online advertising system 110 may include one or more hardware components such as, for example, a central processing unit (CPU) or microprocessor 120a, a random access memory (RAM) module 120b, a read-only memory (ROM) module 120c, a memory or data storage module 120d, a database 120e, one or more input/output (I/O) devices 120f, and an interface 120g. Alternatively and/or additionally, online advertising system 110 may include one or more software media components such as, for example, a computer-readable medium including computer-executable instructions for performing methods consistent with certain disclosed embodiments. It is contemplated that one or more of the hardware components listed above may be implemented using software. For example, storage 120d may include a software partition associated with one or more other hardware components of online advertising system 110. Online advertising system 110 may include additional, fewer, and/or different components than those listed above. It is understood that the components listed above are exemplary only and not intended to be limiting.

CPU 120a may include one or more processors, each configured to execute instructions and process data to perform one or more functions associated with online advertising system 110. As illustrated in FIG. 1, CPU 120a may be communicatively coupled to RAM 120b, ROM 120c, storage 120d, database 120e, I/O devices 120f, and interface 120g. CPU 120a may be configured to execute sequences of computer program instructions to perform various processes, which will be described in detail below. The computer program instructions may be loaded into RAM 120b for execution by CPU 120a.

RAM 120b and ROM 120c may each include one or more devices for storing information associated with an operation of online advertising system 110 and/or CPU 120a. For example, ROM 120b may include a memory device configured to access and store information associated with online advertising system 110, including information for identifying, initializing, and monitoring the operation of one or more components and subsystems of online advertising system 110. RAM 120b may include a memory device for storing data associated with one or more operations of CPU 120a. For example, ROM 120c may load instructions into RAM 120b for execution by CPU 120a.

Storage 120d may include any type of mass storage device configured to store information that CPU 120a may need to perform processes consistent with the disclosed embodiments. For example, storage 120d may include one or more magnetic and/or optical disk devices, such as hard drives, CD-ROMs, DVD-ROMs, or any other type of mass media device. Alternatively or additionally, storage 120d may include flash memory mass media storage or other semiconductor-based storage medium.

Database 120e may include one or more software and/or hardware components that cooperate to store, organize, sort, filter, and/or arrange data used by online advertising system 110 and/or CPU 120a. For example, database 120e may include data associated with video advertisement segments, such as information indicative of the categories of subject matter, topics, and keywords associated with each video advertisement segments stored therein. CPU 120a may access the information stored in database 120e to identify video advertisement segments that correspond to identified topics, keywords, or relevant subject matter contained in the websites on which the relevant video advertisement segments are to be published. CPU 120a may also be configured to receive, collect, and analyze user-interaction data from one or more of the publisher websites, the user interaction data corresponding to a user interaction with the published video advertisement segment(s). This user interaction data may be recorded and used to determine a cost basis for the video advertising segment based, at least in part, on the type or amount of user interaction with the video advertisement segment. It is contemplated that database 120e may store additional and/or different information than that listed above.

I/O devices 120f may include one or more components configured to communicate information with a user (such as publisher or advertiser) associated with online advertising system 110. For example, I/O devices 120f may include a console with an integrated keyboard and mouse to allow a user to input parameters associated with online advertising system 110. I/O devices 120f may also include a display including a graphical user interface (GUI) for outputting information on a display monitor. I/O devices 120f may also include peripheral devices such as, for example, a printer for printing information associated with online advertising system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 120g may include one or more components configured to transmit and receive data via a communication network, such as the Internet, a local area network, a workstation peer-to-peer network, a direct link network, a wireless network, or any other suitable communication platform. For example, interface 120g may include one or more modulators, demodulators, multiplexers, demultiplexers, network communication devices, wireless devices, antennas, modems, and any other type of device configured to enable data communication via a communication network. According to one embodiment, interface 120g may be coupled to or include wireless communication devices, such as a module or modules configured to transmit information wirelessly using Wi-Fi or Bluetooth wireless protocols.

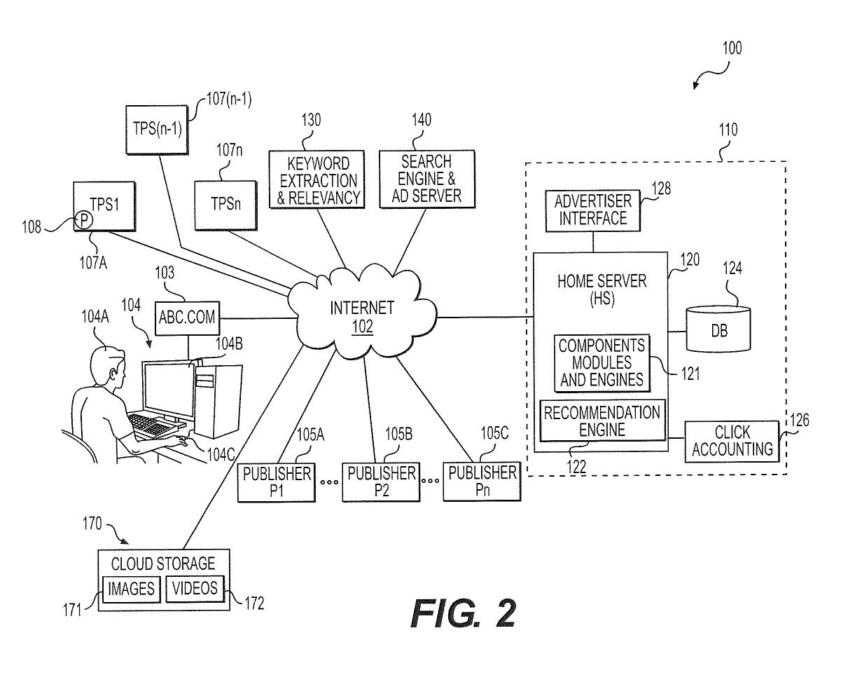

FIG. 2 provides a block diagram illustrating certain components associated with online advertising environment 100. As explained, online advertising environment 100 includes an online advertising system 110, which may be linked, directly or indirectly, wired, wirelessly, or combinations thereof, to network 102, including a communications or computer network, such as a wide area network (WAN), that is, for example, a public network, such as the Internet 24. Online advertising system 110 may be, for example, a computer system, formed of various servers, server components, computers, computer components, computerized components, machines, workstations and the like, and includes a home server (HS) 120, also known as the main server.

Home server 120 may include one or more servers, server components, computers, computer components, computerized components, machines, workstations and the like, and may be associated with storage media, and processors, both internal and external. Home server 120 may also include, or be associated with, computers, machines, computer and computerized devices and/or components, processors, storage media, modules, engines, and combinations thereof. Home server 120 is detailed further below.

There are, for example, numerous servers that work in conjunction with the online advertising system 110, and are linked directly or indirectly, wired or wirelessly, or combinations thereof, to the network 120. These servers, for example, include third party servers (TPS1-TPSn) 107a-107n, each representative of third party, typically unrelated to the online advertising system 110, and publisher servers (P I-Pn) 105a-105c, representative of various publishers, typically unrelated to the online advertising system 110. There is also a server 130 for keyword extraction and relevancy determination, and may include or embody any service suitable for extracting keywords and performing relevancy determinations from these keywords, by assigning relevancy scores. Online advertising environment 100 may also include a search engine server 140, which may include any suitable Internet search engine. Search engine server 140, for example, functions as a search engine, like that, for example of Bing (www.bing.com. From Microsoft of Redmond Wash.), Yahoo™ (www.yahoo.com), Google, or any other online search website. Servers 130 and 140 may be part of the online advertising system 110, but may also be independent of the online advertising system 110, as shown.

Online advertising environment 100 may also include domain servers such as, for example, server 103, which hosts the domain abc.com. Server 103 is representative of a multitude of domain servers linked to network 102 (illustrated as the Internet), as detailed above. Domain server 103 supports a end user computer 104 of an end user 104a, which accesses the various servers linked to network 102, such as the publisher servers 105a-105c, the third party servers 107a-107n, and the home server (HS) 120.

The servers associated with online advertising environment 100 are linked (either directly or indirectly) to each other and an endless number of other servers and the like, via the network, for example, the Internet 102. These servers associated with online advertising environment 100 are arranged along the network 102, so they are in electronic and/or data communication, directly or indirectly, with each other.

As explained, each of the servers and systems associated with online advertising environment 100 may include multiple components for performing the requisite functions as detailed below, and the components may be based in hardware, software, or combinations thereof. The servers associated with online advertising environment 100 may also have internal storage media and/or be associated with external storage media, which functions with the server structures and components to perform the server functions detailed herein. These servers and systems may be computer systems, one or more servers, server components, computers, computer components, computerized components, machines, workstations and the like. While various servers have been listed, this is exemplary only, as the present disclosed subject matter can be performed on an endless numbers of servers and associated components, which are in some way linked to a network, such as the Internet 102, both directly and indirectly.

The user 104a, representative of all users of the disclosed subject matter, has (or is associated with) end user system 104. As explained, end user system 104 is linked to a communication network (such as internet 102). End user system 104 may include a monitor or display screen 104b (either standalone or integrated within a housing of end user system 104) and may operated by an activatable pointer, such as a mouse 104c, touchscreen (not shown), eye tracking interface(s), or the like. End user system 104 may include an e-mail client, installed thereon, that provides the user 104a with a unique address and the ability to utilize one or more e-mail addresses. End user system 104 of the user 104a may include a web browser, browsing software, application, or the like, to access web sites or web pages from various servers and the like, on the Internet 102. Some exemplary web browsers/web browsing software/browsing applications include, Internet Explorer® from Microsoft, Redmond, Wash., Netscape® Navigator®, Mozilla Firefox™, Google Chrome, and Apple Safari.

The home server (HS) 120 is of an architecture that includes one or more components, devices, computer devices, modules, engines and the like, for providing numerous additional server functions and operations, for example, web page and web site hosting and administration, web page and text crawling, natural language processing, keyword and text extraction, URL designation, linking to additional servers over the communication network 102, comparison and matching functions, policy and/or rules processing, various search and other operational engines, browser directing and redirecting functions, data sending, storing and receiving, and the like. The home server 120 includes multiple devices, components, and the like, for performing the requisite functions as detailed below, and the devices, components, and the like, may be based in hardware, software, or combinations thereof. As explained, the home server (HS) 120 includes various processors, including microprocessors, for performing the server functions and operations detailed herein, and storage media, either internal or associated therewith, operable with the server components, modules, engines and the like. The home server (HS) 120 may be associated with additional caches, databases, as well as numerous other additional storage media, both internal and external thereto.

The home server (HS) 120 may include a recommendation engine 122, which is configured for searching internal databases, storage media, etc. (of the home server 120) and publisher databases for listings (which result in recommendations for content on the web page being viewed). The home server 120 also includes a database (DB) 124 for storing keywords and rankings (including relevancy rankings) thereof, and a module 126 for click (such as pay-per-click, pay-per-view, etc.) accounting, for example, performing functions such as tracking and mapping clicks, administering pay per click or pay for performance amounts, and the like. While a single home server (HS) 120 is shown, the home server (HS) 120 may be formed of multiple servers, computers, machines, computer and computerized devices and/or components, processors, storage media, modules, engines, and the like.

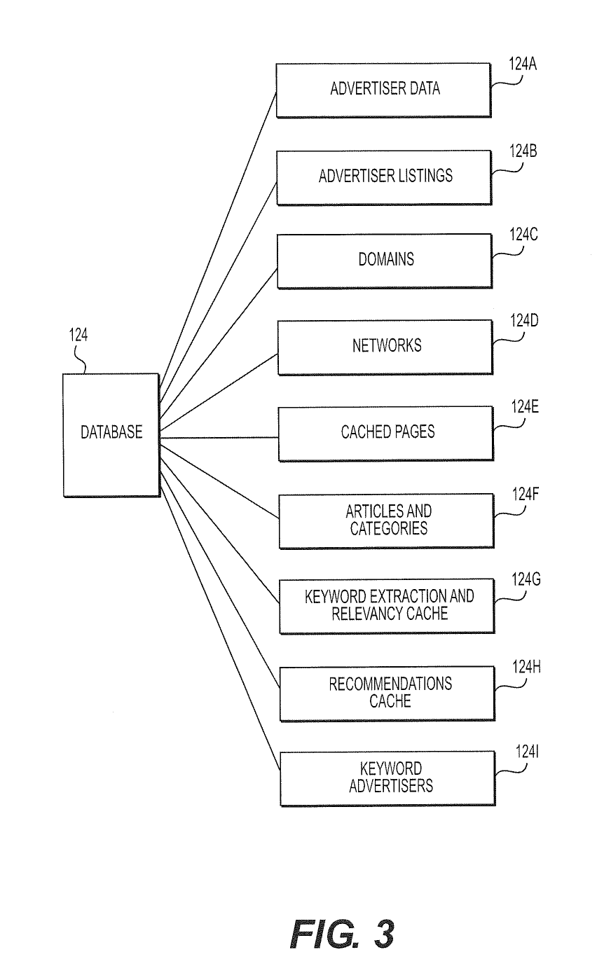

FIG. 3 illustrates an exemplary database 124 associated with online advertising system 110. As illustrated in FIG. 3, database 124 may include a single database with subdatabases and/or caches 124a-124i linked together, but can also be multiple databases and/or caches. The database (DB) 124 shown includes the multiple subdatabases and caches 125a-124i. Multiple other subdatabases and caches are also permissible with the database 1034, but are not shown. These subdatabases and caches include a subdatabase for Advertiser Data 124a, including, for example, URLs of the third party servers hosting the advertiser's content and, accordingly, are associated with the advertiser, listing texts, listing addresses, categories and/or other search terms, and monetary bid amounts for the category or other search term, associated with the particular advertiser.

The advertiser data subdatabase 124a may store advertiser data, received at least in part through the advertiser interface 128. The advertiser data stored in this subdatabase 124a may include, for example, the advertiser name ad URL (for the third party server 107a-107n associated with the advertiser's content), one or more categories, a bid amount (monetary, for example in US Dollars), an address in the system or over the network of the storage media in which the actual listing for the advertiser is stored, including temporary storage, an address in the system or over the network of the storage media in which the image or video advertisement segment for the advertiser is stored.

There is a cache for web pages 124e including web pages and/or articles and other content, which has been, and is constantly being taken from, the World Wide Web (WWW) by crawling applications, engines and modules of the home server 120. The web pages, in particular the articles and content therefrom, are obtained and cached, for example, in real time, and typically before the user, such as the user 104a, has accessed the requisite publisher's web site. Database may also include a keyword extraction and relevancy cache 124g, a recommendations cache 124h, and a keyword advertisers database 124i, each of which are designed to assist online advertising system 110 in identifying video advertisement segments for display on one or more publisher web pages.

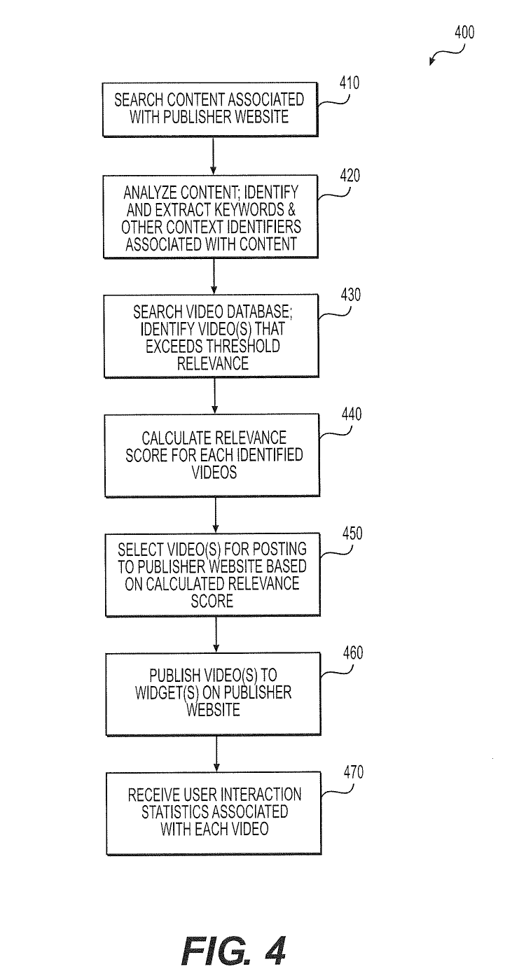

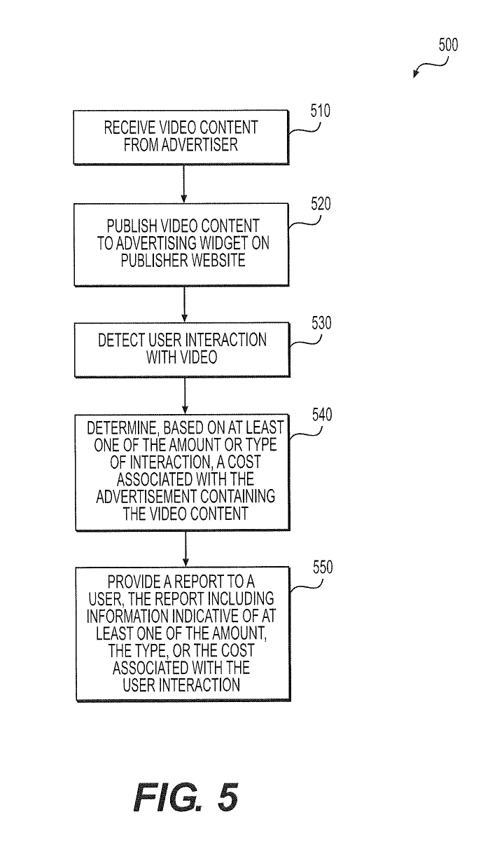

Processes and methods consistent with the disclosed embodiments may enable online advertisement system 110 to provide enhanced video advertisement placement and tracking services for publishers and users alike. For example, features consistent with the presently disclosed embodiments, provide a solution for identifying and publishing video advertisement segments to one or more publisher websites based on the specific subject matter of the content published on the website, tracking user interaction with the video advertising segment, determining a cost-basis for the video advertising segment based on the level of user interaction with the published video content, and generating reports for advertisers and publishers that include statistics associated with the user interaction with the website. FIGS. 4 and 5 provide exemplary flowcharts 400 and 500, respectively, each of which illustrate exemplary method steps associated with context-based video advertising, and which may be implemented in one or more systems associated with online advertising environment 100.

Flowchart 400 of FIG. 4 illustrates one embodiment of a method for context-based video advertising that may be implemented in accordance with certain disclosed embodiments. The method of flowchart 400 commences with a search of content associated with a publisher website (Step 410). The publisher website may be associated with a content publisher that wishes to make certain areas associated with its published website available for displaying third-party advertisements, in exchange for revenue paid by the third party advertisers. There are many different advertising revenue schemes, many of which provide a nominal initial fee for placement of the advertisement, coupled with additional fees based on the level of interaction of users of the website with the advertisement. For example, for banner advertisements, website owners hosting that advertisement may be paid using a “pay-per-click” model, in which the bulk of the advertising revenue is generated when users are redirected from the content publisher website to the advertiser website based on a user's interaction with a portion of the advertisement. Other models, particularly those involving video advertisements, website owners may also be compensated based on the number of legitimate “views” of a video advertisement, even if such “view” does not involve a redirection event. Regardless of the type of pricing scheme employed, it is mutually beneficial for both the website owner and the advertiser for the advertisement published on the website to be relevant to the subject matter of the content published on the website.

Accordingly, online advertising system 110 may include software for identifying areas containing machine-readable content, such as text, natural-language audio content, images, and other forms of machine-readable content. Once areas of machine readable content have been identified, the content may be analyzed to identify context identifiers associated with the content (Step 420). According to one embodiment, context identifiers may include information extracted from the machine-readable content such as, for example, keywords, main topics, frequently used words and phrases, named entities (e.g., people, businesses, places, products, etc.), semantic or contextual relationships between keywords or phrases, language structure identifiers, and other clues that provide insight as to the types of subject matter associated with the content. According to one embodiment, online advertising system 110 may include software for performing information extraction and analysis of content. Alternatively or additionally, content analysis and information extraction may be performed by one or more third party services, such as a third party semantic content analysis services. For example, the machine-readable content may be sent to a keyword extraction and relevancy service 130 where keywords, search terms, or other relevant text, phrases or the like (collectively “keywords”), in natural language, are obtained, and isolated, and assigned relevancy scores. Non-limiting examples of keyword extraction and relevancy service is provided by AlchemyAPI, available from Orchestr8, LLC, 2300 15th Street, Suite 320, Denver, Colo., 80202.

Once the published content has been analyzed to determine key words, topics, and other context identifiers, a video advertisement segment database may be searched, and one or more video advertisement segments that exceed a basic relevancy threshold with the published content may be identified (Step 430). According to one embodiment, software associated with online advertising service 110 may be configured to analyze metadata associated with the various video advertisement segments stored in the video database 124 and isolate, for example, video advertisement segments that share at least one keyword in common with the published content. This exercise may be tuned to identify a relatively small percentage of the video advertisement segments for a more thorough, computationally intensive relevancy analysis for selecting the small number of advertisements that are to be published on the publisher website.

Once a small number of generally-relevant video advertisement segments have been identified, a relevance score associated with each of the identified video advertisement segments may be calculated (Step 440). For example, online video advertising system 110 may be configured to identify context identifiers associated with each of the selected video advertising segments, much in the same way as the published content was analyzed. Specifically, online advertising system 110 may include software for performing information extraction and analysis of content. This software may be capable of performing natural language processing (NLP) or natural language understanding (NLU) analysis of the audio associated with video advertising segments in order to identify the context identifiers associated with the video advertisement. Alternatively or additionally, content analysis and information extraction may be performed by one or more third party services, such as a third party semantic content analysis services. Once the context identifiers associated with each video advertisement segment have been determined, they may be compared with the context identifiers associated with the published website content, and a relevancy score associated with each video segment may be calculated.

Online advertising system 110 may be configured to select one or more of the video segments for publication within a dedicated area or application associates with the publisher website (Step 450), based on the relevancy score associated with the video segments. For example, the video segments having the highest relevancy score may be automatically selected by software associated with online advertising system 110. Alternatively or additionally, a plurality of highly-ranked video segments may be flagged by online advertising system 110, and these segments may be provided to the website publishers for final selection of the video segment to be published.

Once selected, the video advertising segment may be published to the publisher website (Step 460). According to one embodiment, the video advertising segment may be uploaded by online advertising system 110 to an advertisement widget or application window implemented using interactive web technologies such as JavaScript, Flash, HTML5, CSS, or any suitable application interface element for delivering third-party advertising content to a publisher website.

Upon publishing the video advertisement segment to the advertising widget on the publisher website, online advertisement system 110 may be configured to receive information indicative of the user interaction with the widget and/or the video advertisement segment provided therein. Information indicative of the user interaction may include, for example, a type of user interaction, including, but not limited to, one or more commands applied to the video segment by the user. For example, online advertising system 110 may be configured to collect statistics indicative of when the user executes a “pause,” “stop,” or “mute” command to the video advertisement (such commands may be indicative of lack of user interest in the advertisement). Alternatively or additionally, online advertising system 110 may be configured to collect statistics indicative of when a user executes a “play,” “rewind,” or “fast-forward” command to the video advertisement (such commands may be indicative of a higher degree of user interest in the advertisement). According to other embodiment, the number of mouse interactions with the widget (with or without a correspond command) may be monitored and recorded. Alternatively or additionally, information indicative of the user interaction may include an amount of user interaction. Non-limiting examples of the amount of user interaction may include, for example, at least one of a number of different commands issued by the user on the video advertising segment, an amount of the video advertising segment that played, or an amount of cursor interaction with the widget containing the video advertising segment.

According to one exemplary embodiment, online advertising system 110 may be configured to determine a cost associated with the video advertising segment. The cost associated with the video advertising segment may be based, at least in part, on the user interaction with video advertising segment. For example, online advertising system 110 may be configured to determine that the user paused the video advertisement within 2 second of the video segment beginning to play, indicating a lack of user interest in the video advertisement segment. Accordingly, online advertising system 110 may determine that the cost associated with the video segment is nominal.

In another example, online advertising system 110 may determine that the user allowed the video segment to play to completion, increased the volume on the video applet, and rewound the video segment to review a portion of the advertisement, all of which indicate a high level of user engagement with the video segment. As such, online advertising system 110 may calculate the cost basis for the video segment at a relative premium. There are several user interaction criteria and combination thereof that online video advertising system 110 may use to determine a cost associated with video segment(s).

According to one embodiment, online video advertising system 110 may be associated with one or more accounts of publishers and/or advertisers and may be configured to cause a credit or debit to account based on the different revenues/costs associated with video advertisement segments. For example, online advertisement system 110 may be configured to apply a credit to a first account associated with a publisher associated with the publisher website on which a video segment is published. According to one embodiment, the amount of the credit may be based, at least in part, on the cost associated with the video advertising segment. For example, the amount of the credit may be a pre-negotiated percentage of the total cost of the advertisement, as calculated by the level of user interaction with the video segment.

Similarly, online advertising system may be configured to apply a cause the application of a debit to an account associated with an advertiser associated with the video advertising segment published on the publisher's website. According to one embodiment, the amount of the debit may be based, at least in part, on the determined cost associated with the video advertising segment that was calculated in response to the level of user interaction with the video segment.

In addition to matching publisher content with advertisement content, and determining costs bases for each video segment based on user interaction, online advertising system 110 may be configured to generate reports summarizing the user interaction with the video advertising segment. The reports may include, among other things, information indicative of user age demographics, geographical/regional preferences and/or trends associated with the advertisements, user profile information, and other statistics aggregated from multiple user interactions with video advertisement segment. Online advertising system 110 may use this information to adjust cost models associated with video segments, to adjust relevancy factors associated with different age and regional demographics, and customize any other criteria that are used to match video advertising segments to particular online content publishers.

FIG. 5 provides a flowchart 500 illustrating an exemplary process for determining a cost associated with a video advertisement segment that is published in a publisher website. The process commences upon receiving a video advertisement segment from an advertiser (Step 510). According to one embodiment, an advertiser may upload a candidate video advertising segment into an advertising content database 124 associated with online advertising system 110. In addition to the video advertisement segment, the advertiser may provide one or more categories, keywords, topics, or other context information that they would like to associated the video segment with. This information may be contained in searchable metadata associated with the video segment. Online advertising system 110 may search this metadata when trying to identify relevant video advertisement segment(s) for publication on a publisher's website.

If and when a video advertisement segment is selected for publication on a publisher website, online advertising system 110 may be configured to publish the video segment in a widget or applet for presentation to the user when the publisher webpage is requested and served to the user (Step 520). According to one embodiment, online advertising system 110 may be configured to format the video advertisement segment to the appropriate size and resolution associated with the web browser of the user. Once properly formatted online advertising system 110 may serve the requested video segment to the widget on the publisher website.

Online advertising system 110 may be configured to collect information indicative of a user interaction with the video segment (Step 530). As explained above, information indicative of the user interaction may include, for example, a type of user interaction, including, but not limited to, one or more commands applied to the video segment by the user. For example, online advertising system 110 may be configured to collect statistics indicative of when the user executes a “pause,” “stop,” or “mute” command to the video advertisement (such commands may be indicative of lack of user interest in the advertisement). Alternatively or additionally, online advertising system 110 may be configured to collect statistics indicative of when a user executes a “play,” “rewind,” or “fast-forward” command to the video advertisement (such commands may be indicative of a higher degree of user interest in the advertisement). According to other embodiment, the number of mouse interactions with the widget (with or without a correspond command) may be monitored and recorded. Alternatively or additionally, information indicative of the user interaction may include an amount of user interaction. Non-limiting examples of the amount of user interaction may include, for example, at least one of a number of different commands issued by the user on the video advertising segment, an amount of the video advertising segment that played, or an amount of cursor interaction with the widget containing the video advertising segment.

According to one exemplary embodiment, online advertising system 110 may be configured to determine a cost associated with the video advertising segment (Step 540). The cost associated with the video advertising segment may be based, at least in part, on the user interaction with video advertising segment. For example, online advertising system 110 may be configured to determine that the user paused the video advertisement within 2 second of the video segment beginning to play, indicating a lack of user interest in the video advertisement segment. Accordingly, online advertising system 110 may determine that the cost associated with the video segment is nominal.

In another example, online advertising system 110 may determine that the user allowed the video segment to play to completion, increased the volume on the video applet, and rewound the video segment to review a portion of the advertisement, all of which indicate a high level of user engagement with the video segment. As such, online advertising system 110 may calculate the cost basis for the video segment at a relative premium. There are several user interaction criteria and combination thereof that online video advertising system 110 may use to determine a cost associated with video segment(s).

In addition to matching publisher content with advertisement content, and determining costs bases for each video segment based on user interaction, online advertising system 110 may be configured to generate reports summarizing the user interaction with the video advertising segment (Step 550). The reports may include, among other things, information indicative of user age demographics, geographical/regional preferences and/or trends associated with the advertisements, user profile information, and other statistics aggregated from multiple user interactions with video advertisement segment. Online advertising system 110 may use this information to adjust cost models associated with video segments, to adjust relevancy factors associated with different age and regional demographics, and customize any other criteria that are used to match video advertising segments to particular online content publishers.

It will be apparent to those skilled in the art that various modifications and variations can be made to the disclosed systems and methods for measuring orthopedic parameters associated with a reconstructed joint in orthopedic arthroplastic procedures. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for context-based video advertising, comprising:
analyzing, at a computer system, content associated with a publisher website;
identifying, at the computer system, one or more video advertisement segments that exceeds a threshold relevance to the content associated with the publisher website;
providing, by the computer system, the identified one or more of the video advertisement segments for publication to the publisher website;
receiving, at the computer system, information indicative of the user interaction with the video advertising segment on the publisher website; and
determining, by the computer system, a cost associated with the video advertising segment, the cost being based, at least in part, on the user interaction with video advertising segment.

2. The method of claim 1, wherein determining the cost associated with the video advertising segment includes determining that a level of user interaction exceeds a threshold.

3. The method of claim 1, wherein providing the identified one or more of the video advertising segments includes formatting the at least one selected video advertising segment for display in a respective advertising widget on the publisher website.

4. The method of claim 1, further comprising generating, by the processor, a report summarizing the user interaction with the video advertising segment.

5. The method of claim 1, further comprising:
causing, by the processor, a credit to a first account associated with a publisher associated with the publisher website, an amount of the credit being based, at least in part, on the cost associated with the video advertising segment; and
causing, by the processor, a debit to a second account associated with an advertiser associated with the video advertising segment, an amount of the debit being based, at least in part, on the cost associated with the video advertising segment.

6. The method of claim 1, wherein the information indicative of the user interaction includes a type of user interaction, the type of interaction including at least one of a pause command issued by the user on the video advertising segment, a stop command issued by the user on the video advertising segment, or a mute command issued by the user on the video advertising segment.

7. The method of claim 1, wherein the information indicative of the user interaction includes an amount of user interaction, the amount of interaction including at least one of a number of different commands issued by the user on the video advertising segment, an amount of the video advertising segment that played, or an amount of cursor interaction with the widget containing the video advertising segment.

8. A method for context-based video advertising, comprising:
analyzing, by a processor associated with a computer system, content associated with a publisher website;
determining, by the processor, information indicative of a subject matter of the analyzed content;
identifying, by the processor, one or more video advertisement segments that exceeds a threshold relevance to the subject matter of the analyzed content;
calculating, by the processor, a relevance score for each of the identified video advertisement segments;
selecting, by the processor based, at least in part, on the calculated relevance score, at least one of the identified video advertisement segments for publication to a publisher website; and
providing, by the processor, the selected at least one of the video advertisement segment for publication to the publisher website.

9. The method of claim 8, wherein providing the at least one selected video advertising segment includes formatting the at least one selected video advertising segment for display in a respective advertising widget on the publisher website.

10. The method of claim 9, further comprising:
receiving, by the processor, information indicative of the user interaction with the video advertising segment in the advertising widget on the publisher website;
determining, by the processor and based, at least in part, on the information indicative of the user interaction, that a level of user interaction exceeds a threshold; and
determining, by the processor and based, at least in part, on the level of user interaction, a cost associated with video advertising segment.

11. The method of claim 10, further comprising generating, by the processor, a report summarizing the user interaction with the video advertising segment.

12. The method of claim 10, further comprising:
causing, by the processor, a credit to a first account associated with a publisher associated with the publisher website, an amount of the credit being based, at least in part, on the cost associated with the video advertising segment; and
causing, by the processor, a debit to a second account associated with an advertiser associated with the video advertising segment, an amount of the debit being based, at least in part, on the cost associated with the video advertising segment.

13. The method of claim 10, wherein the information indicative of the user interaction includes a type of user interaction, the type of interaction including at least one of a pause command issued by the user on the video advertising segment, a stop command issued by the user on the video advertising segment, or a mute command issued by the user on the video advertising segment.

14. The method of claim 10, wherein the information indicative of the user interaction includes an amount of user interaction, the amount of interaction including at least one of a number of different commands issued by the user on the video advertising segment, an amount of the video advertising segment that played, or an amount of cursor interaction with the widget containing the video advertising segment.

15. The method of claim 8, wherein analyzing content associated with a publisher website includes:
extracting, by the processor, text associated with the publisher website;
providing, by the processor, the extracted text to an information extraction service; and
receiving, by the processor, information indicative of the subject matter of the extracted text.

16. A system for context-based video advertising, comprising:
a video advertising database having stored therein a plurality of video advertising segments;
an information extraction module configured to:
extract content associated with the publisher website; and
identify one or more keywords associated with the extracted content from the information extraction service;
an advertisement interface module communicatively coupled to the video advertising database and the information extraction module, the advertisement interface configured to:
identify one or more video advertisement segments that exceeds a threshold relevance to the content associated with the publisher website, based on the received keywords associated with the extracted content;
provide the identified one or more of the video advertisement segments for publication to the publisher website;
receive information indicative of the user interaction with the video advertising segment on the publisher website; and
determine a cost associated with the video advertising segment, the cost being based, at least in part, on the user interaction with video advertising segment.

17. The system of claim 16, wherein the advertisement interface module is The method of claim 1, wherein determining the cost associated with the video advertising segment includes determining that a level of user interaction exceeds a threshold.

18. The system of claim 16, wherein providing the identified one or more of the video advertising segments includes formatting the at least one selected video advertising segment for display in a respective advertising widget on the publisher website.

19. The system of claim 16, wherein the advertising interface module is further configured to generate, by the processor, a report summarizing the user interaction with the video advertising segment.

20. The system of claim 16, further wherein the advertising interface is further configured to:
cause a credit to a first account associated with a publisher associated with the publisher website, an amount of the credit being based, at least in part, on the cost associated with the video advertising segment; and
cause a debit to a second account associated with an advertiser associated with the video advertising segment, an amount of the debit being based, at least in part, on the cost associated with the video advertising segment.
